(19) United States
(12) Patent Application Publication
(10) Pub. No.: US 2012/0160272 A1
(43) Pub. Date: Jun. 28, 2012

(54) CLEANING METHOD OF SEMICONDUCTOR PROCESS

(75) Inventor: Tsung-Hsun TSAI, Tainan City (TW)

(73) Assignee: UNITED MICROELECTRONICS CORP., HSINCHU (TW)

(21) Appl. No.: 12/977,322

(22) Filed: Dec. 23, 2010

(51) Int. Cl. B08B 3/02; B08B 7/04

(52) U.S. Cl. 134/26; 134/36; 134/33

(57) ABSTRACT

The present invention is to provide a cleaning method to a process for fabricating a semiconductor. The method comprises steps as follows: A semiconductor substrate is first provided. An atomized spray are then continually supplied for a first time interval to clean the semiconductor substrate; and a water film is formed on the surface of the semiconductor substrate at or before a start point of the first time interval to buffer the impact imposed by the atomized spray, wherein the water film is preserved for a second time interval at least partially overlaps the first time interval.

### BACKGROUND

1. Technical Field

Present invention is related to a method for fabricating a semiconductor device, more particularly related to a cleaning method utilized for fabrication a semiconductor device.

2. Description of the Related Art

Static electricity, particles and metal pollutants generated by the processes for fabricating a semiconductor device is typically accumulated on the surface of the semiconductor device. The static electricity particles and metal pollutants accumulated on the surface of the semiconductor device may induce undesirable electrostatic discharge (ESD) to result in device pattern damage or ignition of organic solvents and related fire or explosion hazards. Thus most of the semiconductor fabricating system requires a cleaning process to remove the static electricity, particles and metal pollutants to improve the yields of the semiconductor device.

However, the conventional water cleaning process that may impose a certain impact to damage the pattern of the semiconductor can not be applied for advanced process. Accordingly atomized spry water is applied to clean the surface of the semiconductor wafer during the cleaning process. FIG. 1 illustrates a cleaning process utilizing atomized spry water in accordance with prior art. The prior cleaning process is utilizing a nozzle 102 to provide an atomized spray 104 that are made by a mixture of pure water and nitrogen (N2) gas to clean the surface of the semiconductor wafer 106.

Nevertheless, undesirable ESD due to the static electricity accumulated by the preceding process may still occur at the beginning as the atomized spray is delivered in contact with the surface of the semiconductor wafer 106, up to now the pattern damage or related fire or explosion hazards triggered by the accumulated static electricity is still unavoidable.

### BRIEF SUMMARY

Therefore, it is necessary to provide an improved wafer cleaning method to solve the problems of static electricity accumulation during the process of fabricating the semiconductor.

Other objectives, features and advantages of the present invention will be further understood from the further technological features disclosed by the embodiments of the present invention wherein there are shown and described preferred embodiments of this invention, simply by way of illustration of modes best suited to carry out the invention.

One aspect of the present invention is to provide a cleaning method to a process for fabricating a semiconductor. The method comprises steps as follows: A semiconductor substrate is first provided. An atomized spray are then continually supplied for a first time interval to clean the semiconductor substrate; and a water film is formed on the surface of the semiconductor substrate at or before a start point of the first time interval to buffer the impact imposed by the atomized spray, wherein the water film is preserved for a second time interval at least partially overlaps the first time interval.

In some embodiments of the present invention, the semiconductor substrate is a wafer.

In some embodiments of the present invention, the semiconductor substrate can be rotated with a rotation rate ranges from 2000 rpm to 30 rpm during the cleaning process.

In some embodiments of the present invention, the cleaning process is started at a position departs from the center of the wafer, and the cleaning process is conducted backwards and forwards between the wafer center and an area where departs from the wafer edge for about 3 mm.

In some embodiments of the present invention, the atomized spray is made of a first deionized water (DI water) atomized to a nitrogen (N₂) gas source. In some embodiments of the present invention, the nitrogen (N₂) gas source has a flow rate ranges from 5 to 100 l/min. In some embodiments of the present invention, the first DI water has a flow rate ranges from 10 to 300 ml/min.

In some embodiments of the present invention, the water film is formed by providing a second DI water to blanket over the surface of the semiconductor substrate.

In some embodiments of the present invention, the water film further comprises a gas having a low electrical resistance dissolved therein. In some embodiments of the present invention, the second DI water used to form the water film has a flow rate substantially of 1500 ml/min.

In some embodiments of the present invention, the flow rate of the second DI water used to form the water film may be decreased progressively as time goes on.

In some embodiments of the present invention, the flow rate of the second DI water is greater than that of the first DI water used to form the atomized spray.

In one embodiment of the present invention, the distance between the positions where the atomized spray and the second DI water are ejected out is less than 3 cm.

In one embodiment of the present invention, the second time interval ranges about 20 microseconds (μ sec) to 200 seconds.

In one embodiment of the present invention, the second time interval is shorter than the first time interval. In a preferred embodiment of the present invention, the second time interval is synchronic with the first time interval.

In accordance with the embodiments of the present invention, the cleaning method of the present invention is to provide a water film at or before a start point of supplying an atomized spray for cleaning a surface of a semiconductor device, wherein the water film is preserved for a second time interval at least partially overlaps the start point to buffer the impact imposed by the atomized spray, thus the static electricity accumulated on the surface of the semiconductor can be removed more efficiently by the water film, and undesirable ESD can also be avoided. Therefore, the problems of device pattern damage or related fire or explosion hazards triggered by the accumulated static electricity can be solved.

In order to make the aforementioned and other objects, features and advantages of the present invention comprehensible, preferred embodiments accompanied with figures are described in detail below.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates a cleaning process utilizing atomized spry water in accordance with prior art.

FIG. 2 illustrates a semiconductor cleaning process in accordance with one embodiment of the present invention.

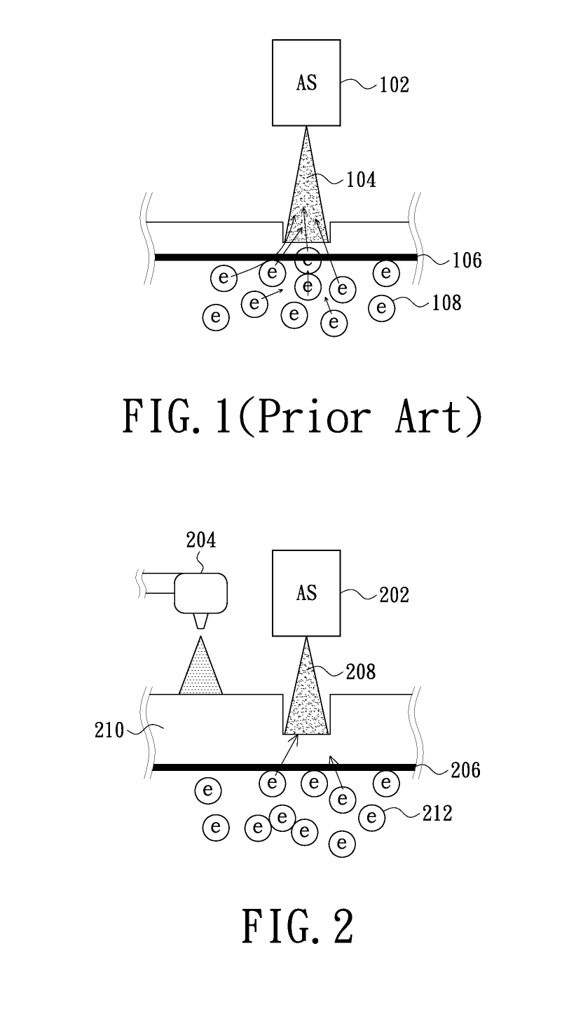

### DETAILED DESCRIPTION

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

Semiconductor chemical cleaning process involves a standard cleaning procedure 1 and a standard cleaning procedure 2 used to remove the contaminants accumulated on a wafer surface. The standard cleaning procedure 1 is typically applied to remove particles, organic contaminants and metal ions from the wafer surface by weak alkaline solution, and the standard cleaning procedure 2 is primarily used to remove metal ions.

After the chemical cleaning a DI water cleaning process is applied to remove the static charges generated by the chemical cleaning process. However, the conventional DI water cleaning may induce undesirable ESD as the atomized spray in contact with the semiconductor substrate to cause device pattern damage or ignition of organic solvents and related fire or explosion hazards at. Thus the object of the present invention is to provide an improved wafer cleaning method to solve the problems of static electricity accumulation during the process of fabricating the semiconductor.

FIG. 2 illustrates a semiconductor atomized spry cleaning process in accordance with one embodiment of the present invention. Referring to FIG. 2, the cleaning process of the present embodiment is conducted by utilizing an atomizing nozzle 202 and a fluid nozzle 204. A semiconductor substrate 206 is first provided; preferably the semiconductor substrate 206 is a semiconductor wafer. In the present embodiment, the semiconductor substrate 206 is disposed on a wafer handling device (not shown) that can drive the semiconductor wafer rotating at a certain speed rate, for example ranges from 2000 rpm to 30 rpm.

An atomized spray 208 is then continually supplied for a first time interval to purge the surface of the semiconductor substrate 206. In the present embodiment, the atomizing nozzle 202 atomizing nozzle 202 is equipped with nitrogen (N2) gas source (not shown) having a flow rate ranges from 5 l/min to 100 l/min to atomize a first DI water in to form the atomized spray 208 and ejects the atomized DI water on to the central surface of the semiconductor substrate 206, wherein the first DI water has a flow rate rages from 10 ml/min to 300. The position where the atomized spray 208 is ejected may depart from the wafer center for a certain distance. In the present embodiment, the atomizing nozzle 202 is disposed on the surface of the semiconductor substrate 206, and the position where the atomized spray 208 is ejected from the atomizing nozzle 202 departs from the wafer center about 3 mm. The atomizing nozzle 202 can be derived backwards and forwards between the wafer center and the area where departs from the wafer edge for about 3 mm.

In general, to utilize atomized spray 208 to clean a wafer surface has following advantages: On the one hand, particles, dust and pollutants agglutinating on the surface of the semiconductor substrate 206 can be removed; and on the other hand, the impact by fluid cleaning liquid which is directly imposed on to the surface of the semiconductor substrate 206 can be avoided, thus the circuit pattern formed on the surface of the semiconductor substrate 206 could not be damaged.

However, merely utilizing atomized spray 208 to clean the surface of semiconductor substrate 206 may induce undesirable ESD, by which some parts of the circuit pattern of the semiconductor may be exploded like a volcano as the atomized spray 208 in contact with the semiconductor substrate 206. Thus the embodiments of the present invention applies a the fluid nozzle 204 ejecting a second DI water to form a water film 210 with a certain thickness on the semiconductor substrate 206 at or before the start point the atomizing nozzle 202 provides the atomized spray, so as to buffer the impact imposed by the atomized spray 208. Wherein the atomized spray 208 used to clean the surface of the semiconductor substrate 206 is continually supplied for a first time interval, and the water film 210 should be preserved for a second time interval at least partially overlaps the first time interval. In one embodiment of the present invention, the second time interval ranges about 20 microsecond (μ sec) to 200 seconds.

In sum, the object of forming the water film 210 is to remove the static electricity accumulated on the surface of the semiconductor substrate 206 in order to avoid pattern damage or related fire or explosion hazards triggered by undesirable ESD of the static electricity. In other words, the water film 210 should exist simultaneously at the beginning as the atomized water spray 208 in contact with the surface of the semiconductor substrate 206 to remove the static electricity accumulated on the surface of the semiconductor substrate 206.

Of noted that most of the static electricity accumulated on the surface of the semiconductor substrate 206 may be substantially removed by the water film 210 at the beginning as the atomized spray 208 in contact with the surface of the semiconductor substrate 206. (The static electricity accumulated on the surface of the semiconductor substrate 206 may be substantially removed by the water film 210 after the water film 210 is formed about 1 second) In other words, only if the second time interval overlaps the start point of the first time interval, most of the static electricity accumulated on the surface of the semiconductor substrate 206 can be removed, and undesirable ESD can be avoided, no matter how long the second time interval continues. Thus the second time interval may be shorter or longer than or even equal to the first interval the start point of the first time interval. In the present embodiment, the second interval is preferably synchronic with the first interval.

In addition, it should be appreciated by those skilled in the art, when the flow rate of the atomized spray 208 ejected from the atomizing nozzle 202 is increased, the particle removing rate of the atomized spray 208 may be reduced correspondingly. Thus it is a better way to maintain the original flow rate of the atomized spray 208 ejected from the atomizing nozzle 202 and at the same time to form a water film, such as the water film 210, on the surface of the semiconductor substrate 206 simultaneously as the ejection of the atomized spray 208. Alternatively, in some other embodiments, the flow rate of the atomized spray 208 or the flow rate of the second DI water may be reduced gradually after the start point of the first time interval, whereby and the thickness of the water film 210 can be decreased progressively as time goes on, so as to enhance the atomized spray 208 removing the particles and pollutants agglutinating on the surface of the semiconductor substrate 206.

In some embodiments of the present invention, the atomizing nozzle 202 and the fluid nozzle 204 are disposed apart from each other for a distance less than about 3 cm. In some embodiments of the present invention, the distance between the atomizing nozzle 202 and the fluid nozzle 204 is about 18˜20 mm. The water film 210 is a DI water film blankets over the surface of the semiconductor substrate 206, and the volume of the DI water film is greater than the total volume of the atomized spray 208. Since the static electricity 212 accumulated on the surface of the semiconductor substrate 206 can be removed by the water film 210 at the beginning when the atomized spray 208 in contact with the semiconductor substrate 206, the undesirable ESD can be avoided.

In some embodiments of the present invention, the water film 210 further comprises a gas having a low electrical resistance dissolved therein to enhance the water film 210 removing the static electricity 212, wherein the gas is carbon dioxide (CO₂) gas. In the present embodiment, the fluid nozzle 204 is used to provide the second DI water and associate a certain volume of CO₂ gas dissolved therein as the DI water flowing out of the fluid nozzle 204 to enhance the static electricity 212 removing.

In accordance with the embodiments of the present invention, the cleaning method of the present invention is to provide a water film simultaneously with supplies of an atomized spray for cleaning a surface of a semiconductor device, thus the static electricity accumulated on the surface of the semiconductor can be removed more efficiently by the water film, and undesirable ESD can also be avoided. Therefore, the problems of device pattern damage or related fire or explosion hazards triggered by the accumulated static electricity can be solved.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method for cleaning a semiconductor wafer, comprising:
providing a semiconductor substrate;
supplying an atomic spray continually for a first time interval to clean the semiconductor substrate;
forming a water film on a surface of the semiconductor substrate at or before a start point of the first time interval to buffer a impact imposed on the surface of the semiconductor substrate by the atomized spray, wherein the water film is preserved for a second time interval at least partially overlaps the first time interval.

2. The method as claimed in claim 1, wherein the semiconductor substrate is a wafer.

3. The method as claimed in claim 1, wherein the semiconductor substrate can be rotated with a rotation rate ranges from 2000 rpm to 30 rpm during the cleaning process.

4. The method as claimed in claim 1, wherein the cleaning process is started at a position departs from the center of the semiconductor substrate, and the cleaning process is conducted backwards and forwards between the center of the semiconductor substrate and an area where departs from the edge of the semiconductor substrate for about 30 mm.

5. The method as claimed in claim 1, wherein the atomized spray is made of a first deionized water (DI water) atomized by a nitrogen (N₂) gas source.

6. The method as claimed in claim 5, wherein the N₂ gas source has a flow rate ranges from 5 to 100 l/min.

7. The method as claimed in claim 5, wherein the first DI water has a flow rate ranges from 10 to 300 ml/min.

8. The method as claimed in claim 5, wherein the water film is formed by providing a second DI water to blanket over the surface of the semiconductor substrate.

9. The method as claimed in claim 1, wherein the water film further comprises a gas having a low resistance dissolved therein.

10. The method as claimed in claim 9, wherein the gas is carbon dioxide (CO2).

11. The method as claimed in claim 8, wherein the second DI water used to form the water film has a flow rate substantially of 1500 ml/min.

12. The method as claimed in claim 8, wherein the first DI water used to form the water film has a flow rate decreasing progressively as time goes on.

13. The method as claimed in claim 8, wherein the flow rate of the second DI water used to form the water film is greater than that of the first DI water used to form the atomic spray.

14. The method as claimed in claim 8, wherein the distance between the positions where the atomized spray and the second DI water are ejected out is less than 3 cm.

15. The method as claimed in claim 1, wherein the second time interval ranges about 20 microsecond (μ sec) to 200 seconds.

16. The method as claimed in claim 1, wherein the second time interval is shorter than the first time interval.

17. The method as claimed in claim 1, wherein the second time interval is synchronic with the first time interval.

18. The method as claimed in claim 1, further comprising conducting a chemical cleaning process prior the start point of the first interval.
